(19) United States
(12) Patent Application Publication
(10) Pub. No.: US 2005/0098745 A1
(43) Pub. Date: May 12, 2005

(54) Apparatus for detecting distortion of transfer arm robot

(76) Inventor: Kai Peng, Kuching (MY)

Correspondence Address: THI D. DANG;Lawrence Y D Ho & Associates, PMB 400, 2101 Crystal Plaza Arc, Arlington, VA, 22202, US

(21) Appl. No.: 10/703,589

(22) Filed: Nov. 10, 2003

(51) Int. Cl. G01V 8/00; G01N 21/86

(52) U.S. Cl. 250/559.33

(57) ABSTRACT

Apparatus for detecting distortion of transfer arm robot An apparatus for detecting distortion of a transfer arm robot comprising at least an electromagnetic radiation source and at least a sensor for detecting said electromagnetic radiation. The source and sensor may be mounted on a reference plane parallel to the plane of the arm at which portion distortion is to be detected wherein the radiation is reflected off said portion of the arm. The sensor may be mounted at an appropriate distance from the source to receive the radiation reflected by said portion of arm at a normal and distortion-free state. When the sensor is out-of-range to receive radiation reflected by said portion of arm at a distorted state, signal may be generated to alert or halt the operation of the transfer arm or equipment as a whole.

### TECHNICAL FIELD

This invention relates to a transfer arm robot mechanism employed in handling a substrate, such as semiconductor wafer, liquid crystal panel and the like, in a processing equipment therefor. It specifically relates to an apparatus for detecting distortion of a transfer arm robot mechanism where high operating precision is required and may not permit such distortion.

### BACKGROUND ART

In a substrate processing apparatus such as that for processing semiconductor wafer, liquid crystal panel and the like, multiple processes are conducted on each of the substrate wherein each process may be conducted in a processing chamber. Multiple chambers are therefore disposed about a centrally located transfer chamber and a transfer arm robot mechanism is provided in the transfer chamber and programmed to handle a substrate in pre-selected sequence and move them into or out of the processing chambers or load-lock chambers, the latter accommodating a wafer or substrate cassette for stocking up a plurality of substrates in a stack for loading into a processing chamber via the transfer chamber the robot arm, or from a processing chamber to the load-lock chamber upon completion of a process or processes.

The transfer arm robot mechanism has movement which is normally controllable in high precision in all three dimensions of X, Y and Z-axes. While movements in the X and Y-axes, i.e. panning from one chamber to another, by the transfer arm robot requires precision as well, the vertical or up-and-down movement, or Z-axis, of the arm is often problematic, particularly in loading or retrieving a substrate from a load-lock chamber where the stacked substrates in a cassette disposed in such a chamber does not allow much clearance for the end effector of the transfer arm to be inserted in between the stacked substrates for retrieval or loading.

Accordingly, there exist a large number of patents that proposed various means for controlling and adjusting the arm in the Z-axis. U.S. Pat. No. 6,085,125 (Genov) assigned to Genmark Automation, Inc., for instance, provides for sensors for determining a plane in which the silicon wafer or substrate is held by the robot arm blade (also broadly termed “end effector” in the literature) . In principle, the patent provides for proximity sensing of the proximity of end effector of the robot's arm, or a substrate held on the arm end, and then adjust the Z-axis of the robot accordingly. Planarity sensing means involves a plurality of sensors arranged in a known plane outputting signals indicating a distance between each sensors and a closest point on the substrate or end or robot arm.

It should be pointed out that, upon the detection of non- or out-of-alignment, the adjustment or re-orientation or corrective action taken is only in respect of the Z-axis of the robot arm. However, if the blade or end effector is bent, wobbled, warped, sagged, flexed downwardly, etc. (e.g. due to wear, material fatigue, effects of gravity, or as a result of hitting another part of the equipment such as chamber lift pins) such adjustments made to the Z-axis would be ineffective nor compensate the distortion as the Z-axis adjustment would only realign the robot arm as a whole based on the sensed or monitored part (in this case the blade).

In fact, any adjustment attempted along the Z-axis may actually aggravate the situation because, within the wafer cassette, a very narrow clearance is allowed for the space between the blade and the wafer surface. It may be as little as 0.6-0.8 mm¹. With such low tolerance, even a slightly distorted blade may seem to pass normally over a wafer's surface normally without the scratching being apparent and no alarm would be raised. Often, the scratching is unnoticed and the wafer continues to be processed until it reaches the optical inspection stage.

Accordingly, the prior art's Z-axis correction cannot be applied in the event of distortion is detected. In fact, no amount of corrective action may be taken in such situation and the only appropriate action is to immediately stop the operation to avoid further damage and replace the faulty end effector, blade or the arm itself.

In U.S. Pat. No. 6,401,554 (Mori, et. al.) assigned to Applied Materials, Inc., an apparatus specifically arranged to detect distortion of the blade of a transfer robot arm is disclosed. Conceptually, this prior art requires the detection apparatus being set to the cassette stage within one of the load-lock chambers. Accordingly, one of the load-lock chambers has to be modified and dedicated to the detection process and the
¹ According to Inventor's Disclosure (P43)—is this correct? Seems too apparatus installed therein, as with each chamber, within a predetermined degree of vacuum. The wafer cassette has to be removed to accommodate the detection apparatus's housing which is then mounted on the cassette stage.

The apparatus comprises a plurality of distance sensors mounted on the lower face of the upper plate of a housing located within a load-lock chamber. The blade is required to be inserted into the housing for the sensors to detect. Each sensor is of the non-contact type, preferably laser type, and measures the distance between the blade inserted into the housing and the lower plate.

Process involves taking over the control of stepping motor that moves the cassette stage up and down, and sending pulses to move the stepping motor incrementally. The blade positions corresponding to the number of pulses sent to move the stepping motor and the distance measured by the sensors are then tabulated. The degree of inclination of the blade is given by the difference between the distance of the first (outermost) sensor and the last (innermost) sensor. As such, both the process and the apparatus are complicated.

### OBJECTS OF THE INVENTION

It is an object of the present invention to provide for an apparatus for detecting distortion of a transfer arm robot, in particular, the end effector or the blade. Specifically, the apparatus is simple in configuration and may be installed on a reference plane at any location outside of the load-lock or process chambers, such as at any position within the transfer chamber.

The simplicity of the apparatus affords a detection method that does not require taking control of any of the chambers'mechanisms or the need to collate and tabulate data before the results may be known if distortion is detected.

It is a further object of the invention to enable the detection means to directly or automatically stop the operation of the robot arm once distortion is detected without the need for data analysis and decision-making.

### STATEMENT OF DISCLOSURE

According to the general embodiment, the apparatus of the invention comprises of at least an electromagnetic radiation source and at least a sensor for detecting said electromagnetic radiation, said source and sensor are mounted on a reference plane parallel to the plane of the arm at which portion distortion is to be detected. The radiation is characterised in that it is reflected off said portion of the arm. The sensor is characterised in that it is mounted at an appropriate distance from the source to receive the radiation reflected by said portion of arm at a normal and distortion-free state, or is out-of-range to receive radiation reflected by said portion of arm at a distorted state.

In one preferred embodiment, the radiation source and sensor are mounted on a horizontal reference plane parallel to the horizontal plane of the arm. Preferably, the reference plane is buffer or transfer chamber's base plate.

In another preferred embodiment, the portion of the transfer arm to be detected for distortion is the distal end of said arm, including the end-effector, blade and the like. The distortion to be detected includes warpage, sagging, flexure, wobble and like states of said distal end of the arm.

The sensor is preferably mounted at an appropriate pitch to receive the reflected radiation. The position of the sensor is preferably adjustable, including any one or both of its distance from the source and pitch, to receive radiation reflected by said portion of arm at a normal and distortion-free state.

In yet another preferred embodiment, the detection of distortion may trigger a signal to stop the arm from operating further and/or activate an alarm.

In another aspect of the invention, it is provided a method for detecting distortion of a transfer arm robot comprising radiating an electromagnetic radiation to a portion of said arm in which distortion is to be detected and sensing said electromagnetic radiation reflected from said portion of said arm, wherein the points of radiating and sensing are provided upon a reference plane parallel to the plane of the said portion of said arm; wherein the sensing point is provided at an appropriate distance from the radiating point to receive the radiation reflected from said portion of arm at a normal and distortion-free state; and wherein said sensing point is out-of-range to detect the radiation reflected by said portion of arm at a distorted state.

Preferably, the detection point is provided at an appropriate pitch to receive the radiation reflected from said portion of arm at a normal and distortion-free state, and wherein said detection point is out-of-range to receive radiation reflected by said portion of arm at a distorted state.

### LIST OF ACCOMPANYING DRAWINGS

The apparatus and method of the present invention will be better understood with the following detailed description with reference to the accompanying drawings, which describes an embodiment as an example or illustration, in which

FIG. 1 shows a perspective view and a corresponding simplified cross-sectional view of an exemplary end effector or blade of a transfer arm robot;

FIG. 2 shows a schematic elevation view of a substrate or wafer cassette wherein 3 wafers are shown stacked in load and a blade shown inserted in between the second and third wafers;

FIG. 3 shows in isolation a detection apparatus according to the present invention;

FIG. 4 shows the detection of a normal, non-distorted blade;

FIG. 5 shows the detection of a distorted blade;

FIG. 6 shows a signal logic flowchart of detection; and

FIG. 7 shows a schematic elevation view of an apparatus being installed to detect at the load-lock position of the transfer arm blade.

### DETAILED DESCRIPTION OF SPECIFIC EMBODIMENTS

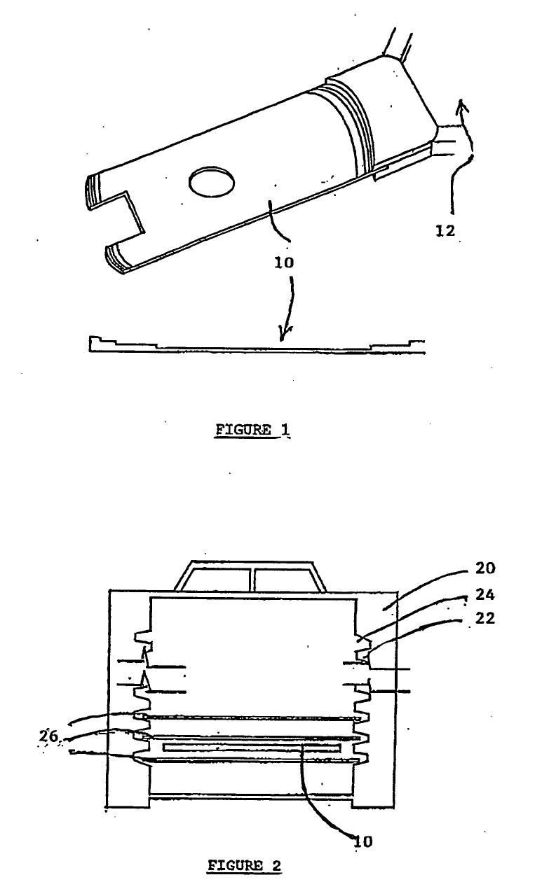

FIG. 1 shows an end effector or blade (10) which is typically the distal end of a transfer arm robot (12). The blade (10) is shown in perspective view (top drawing) and in simplified cross-sectional view (bottom drawing).

FIG. 2 shows a schematic elevation view of a substrate or wafer cassette (20) wherein notches (22) are provided on opposing sides for the wafers to be inserted and stacked in individual slots (24). Three wafers (26) are shown stacked in their respective slots at the lower portion of the cassette (20) while a blade (10) is shown inserted in between the second and third wafers. As aforementioned, the clearance between the blade and the surface of the wafer may be as narrow as 0.6-0.8 mm.

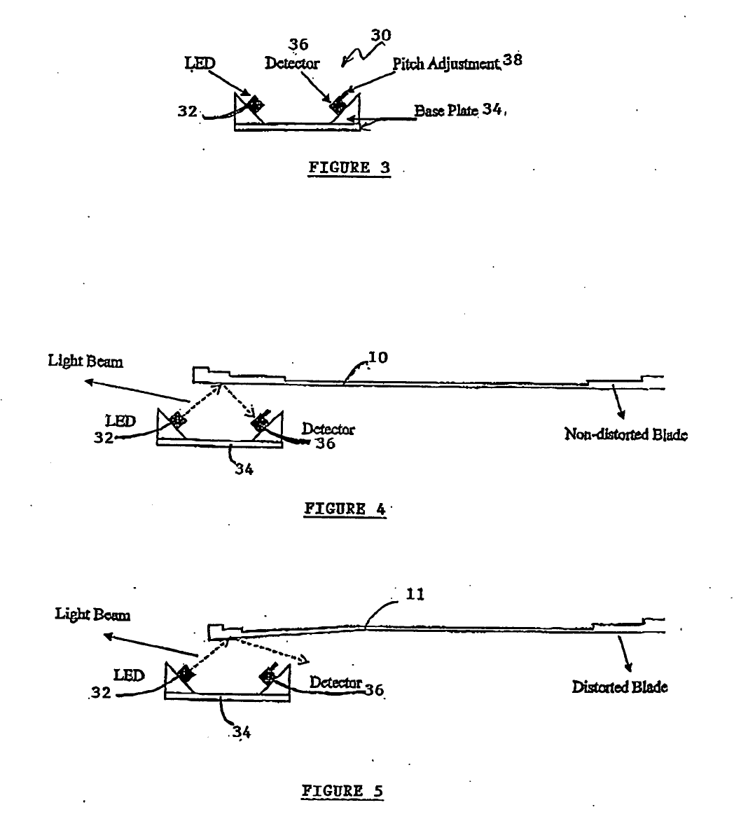

FIG. 3 shows the apparatus (30) according to a specific embodiment of the invention wherein is shown an electromagnetic radiation source (32) mounted at a pitch on one end of a base plate (34). An electromagnetic radiation sensor (36) may be, for example, a light-emitting diode (LED), and is mounted on the other end of a base plate (34), and is also mounted at a pitch complementary to that of the source (32) whereby both the light emanating from the LED source (32) may be reflected by the bottom surface of a normal, non-distorted blade (10) over the apparatus (30) may be picked up by sensor (36) as shown in FIG. 4.

At least one of the LED source (32) or sensor (36) may be provided with pitch adjustment means (38) so that the reflection off the bottom surface of the blade (10) may fall within the pick-up field of the sensor (36). Although the examples herein show the pitch adjustment means (38) being provided on the sensor (36) while the source (32) has its pitch fixed on the base plate (34), it is obvious that the reverse, i.e. the pitch adjustment means is provided on the LED source (32) and the sensor's (36) pitch is fixed, is possible or that both sensor (36) and source (32) may be so provided. Apart from the pitch, it will be appreciated by a skilled person that the distance between the source (32) and sensor (36), and the distance of the blade above the apparatus (30) are parameters that determine the reflection, and which must be adjusted and calibrated accordingly. These parameters are shown as preferably fixed in the present example.

As shown in FIG. 5, a distorted blade (11) will have its distal end sagged or flexed downwards resulting in a non-level bottom surface whereby the light from LED source (32) becomes reflected off the surface at a different angle and fall outside of the field detectable by the sensor (36).

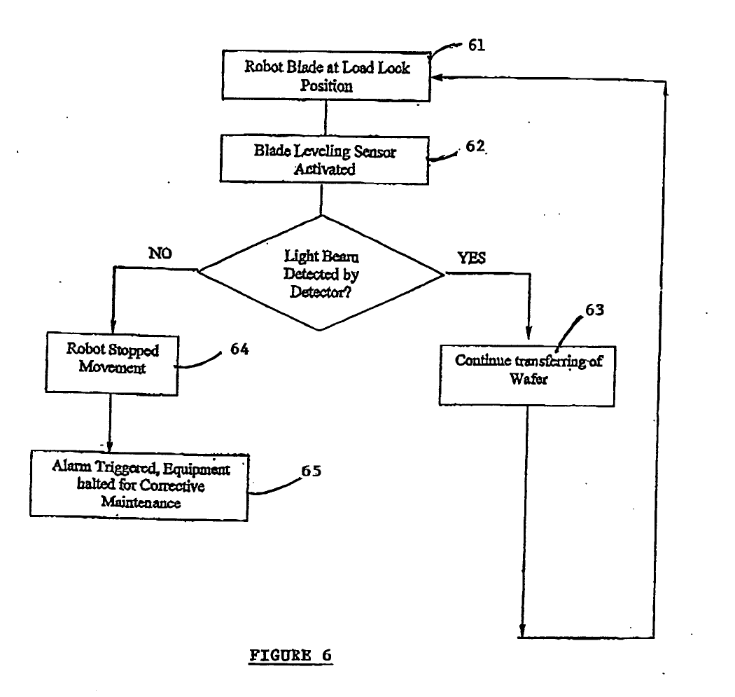

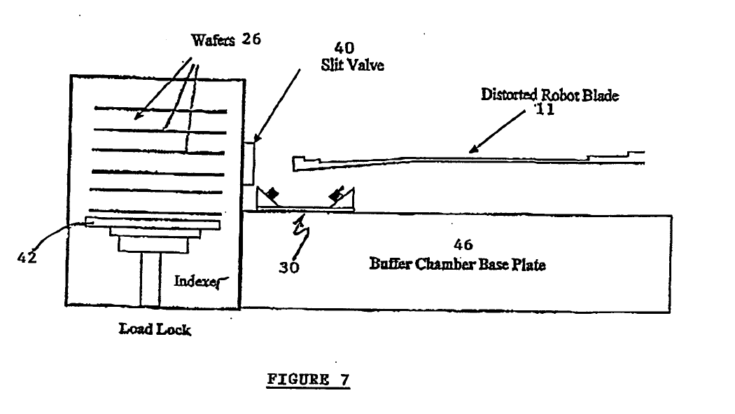

The non-detection of the LED light by the sensor (36) may trigger a signal that warns or halt the operation of the transfer arm (12). An example of such a signal logic flow-chart is shown in FIG. 6. In this example, the detection apparatus (30) is placed to detect the blade at the load lock position, i.e. immediately outside the load-lock chamber with the blade (11)—in this instance, a distorted blade is shown—poised to enter the chamber to access the cassette (20) via a slit valve (40) to handle the wafers (26) stacked inside the cassette (20) as shown schematically in FIG. 7. The specific wafer may be accessed by the precise vertical movements of the cassette base (42) which is actuated by an indexer (44). The detection apparatus (30) may be mounted on the transfer or buffer chamber's base plate (46) which acts as a reference plane in parallel with the transfer arm's X-Y plane.

Referring back to FIG. 6, the source (32) and the sensor (36) may be activated (62) upon the blade (10) reaches the load-lock position, i.e. just outside the slit valve (40) of the load-lock chamber. Upon detection of the light beam by the sensor (36), the transfer arm operation is allowed to continue (63). However, if the light beam is not detected, the transfer arm operation is stopped immediately (64) and optionally, alarm may be trigger and the entire equipment's operation is halted (65) to allow for corrective maintenance to be carried out.

Although the foregoing drawings show the detection apparatus (30) being mounted in an orientation which is longitudinal to, or lengthwise of, the transfer arm blade (10) for the detection of downward flexure or sagging of the blade, it should be appreciated that the apparatus (30) may be mounted widthwise of the blade (10) to detect incidences of sidewise rolling of the blade.

From the above description on the general concept, features and working principles of the invention and its specific embodiments, it would be obvious to a person skilled in the art that there are many variations and alternative embodiments that may possibly be used in substitution of the aforesaid parts, materials, steps or processes. Many of the various parts, components, materials and alternative configurations or embodiments that are not specifically described herein may be used to effectively work the concept and working principles of this invention. They are not to be considered as departures from the present invention but shall be considered as falling within the letter and scope of the following claims.

1. An apparatus for detecting distortion of a transfer arm robot comprising at least an electromagnetic radiation² source and at least a sensor for detecting said electromagnetic radiation, said source and sensor are mounted on a reference plane parallel to the plane of the arm³ at which portion⁴ distortion is to be detected
² This should cover all range of E-M spectrum that may be used.
³ Covers all directions of distortion, not just vertical distortion on a horizontal plane.
⁴ “That portion of the arm” covers any part of the arm that we want to
wherein the radiation is reflected off said portion of the arm;
wherein the sensor is mounted at an appropriate distance from the source to receive the radiation reflected by said portion of arm at a normal and distortion-free state; and
wherein said sensor is out-of-range to receive radiation reflected by said portion of arm at a distorted state.

2. An apparatus according to claim 1 wherein the radiation source and sensor are mounted on a horizontal reference plane parallel to the horizontal plane of the arm.

3. An apparatus according to claim 2 wherein the portion of the transfer arm to be detected for distortion is the distal end of said arm, including the end-effector, blade and the like.

4. An apparatus according to claim 3 wherein the distortion to be detected includes warpage, sagging, flexure, wobble and like states of said distal end of said arm.

5. An apparatus according to claim 2 wherein the reference plane is buffer⁵ chamber's base plate.
⁵ To define to include “transfer” or “intermediate” chamber.

6. An apparatus according to claim 1 wherein the sensor is mounted at an appropriate pitch⁶ to receive the reflected radiation.
⁶ Pitch may be additional to distance, or in substitution of distance. For light that is non-focused (unlike laser), pitch may be more important

7. An apparatus according to claim 1 wherein the position of the sensor is adjustable, including any one or both of its distance from the source and pitch, to receive radiation reflected by said portion of arm at a normal and distortion-free state.

8. An apparatus according to claim 1 wherein the detection of distortion triggers signal to stop the arm from operating further and/or activate an alarm.

9. A method for detecting distortion of a transfer arm robot comprising radiating an electromagnetic radiation to a portion of said arm in which distortion is to be detected and sensing said electromagnetic radiation reflected from said portion of said arm,
wherein the points of radiating and sensing are provided upon a reference plane parallel to the plane of the said portion of said arm;
wherein the sensing point is provided at an appropriate distance from the radiating point to receive the radiation reflected from said portion of arm at a normal and distortion-free state; and
wherein said sensing point is out-of-range to detect the radiation reflected by said portion of arm at a distorted state.

10. A method according to claim 9 wherein the detection point is provided at an appropriate pitch to receive the radiation reflected from said portion of arm at a normal and distortion-free state, and wherein said detection point is out-of-range to receive radiation reflected by said portion of arm at a distorted state.
